(19) United States
(12) Patent Application Publication
(10) Pub. No.: US 2016/0177557 A1
(43) Pub. Date: Jun. 23, 2016

(54) SEALING INSERT FOR A WATER OUTLET

(71) Applicant: wedi GmbH, Emsdetten (DE)

(72) Inventor: Stephan Wedi, Emsdetten (DE)

(73) Assignee: wedi GmbH, Emsdetten (DE)

(21) Appl. No.: 14/962,044

(22) Filed: Dec. 8, 2015

(30) Foreign Application Priority Data
Dec. 23, 2014 (DE) 102014119584.1

(51) Int. Cl. E03F 5/04; F16L 5/10

(52) U.S. Cl. CPC E03F 5/041; F16L 5/10

(57) ABSTRACT

A sealing insert (100) including an annular body (1) with a side wall (9) and a circumferential collar (13), at least one sealing lip (3, 3′, 3″) which is arranged on the side wall (9) and points outward, wherein in a longitudinal-axial section (Q) through the sealing insert (100), the sealing lip (3, 3′, 3″) comprises in each case a conical contour (K) which ends in an apex (8) and merges into an outside lateral surface (M) of the annular body (1), at least one circumferential bead-like thickening (5) is arranged on the outside lateral surface (M) of the annular body, the sealing lip (3, 3′, 3″) comprises a height (H) which is greater than a spacing (B) provided between the thickening (5), such that a sealing lip (3, 3′, 3″) which folds over in the direction of the thickening (5) is supported on the thickening (5).

### STATEMENT OF RELATED APPLICATIONS

This patent application claims the benefit of and priority on German Patent Application No. 10 2014 119 584.1 having a filing date of 23 Dec. 2014.

### BACKGROUND OF THE INVENTION

The invention relates to a sealing insert for a water outlet, said sealing insert including:
an annular body with a side wall and a circumferential collar,
at least one sealing lip which is arranged on the side wall and points outward,
wherein in a longitudinal-axial section through the sealing insert, the sealing lip comprises in each case a conical contour which ends in an apex and merges into an outside lateral surface of the annular body.

Such sealing inserts are used, for example, in order to seal a waste trap that is inserted into a shower floor element.

### BRIEF SUMMARY OF THE INVENTION

A sealing insert 101 according to the prior art (cf. FIG. 9) is formed by an annular body 1 which includes a side wall 9 and a collar 13 with an upwardly projecting sealing ring 6 which is approximately trapezoidal in its cross section, the smaller trapeze base of which points upward. The outside lateral surface M of the side wall 9 is cylindrical.

The terms: “upward”, “upper”, “downward”, “lower” or “underneath” refer to the arrangement of the sealing insert 101 in its installation position where the collar 13 with the sealing ring 6 faces the shower floor element.

The side wall 9 consists of an outer, elastomer wall layer 11 with three sealing lips 3, 3′, 3″ which are located one on top of another as well as an inner, more rigid wall layer 12. The two wall layers 11, 12 can be connected together in a fixed, non-separable manner or the wall layer 11 is subsequently fitted onto the wall layer 12. The known sealing insert has proved its worth in practice, however there is a need to improve the sealing characteristics. The sealing insert 101 is distinguished by relatively narrow sealing lips of the same cross section. It is possible for the sealing lips to bend over when the annular body is mounted and is subsequently tightened using screw-type elements.

Consequently, the object is to design an improved, novel sealing insert of the type mentioned in the introduction, the sealing lips of which are more sturdy and, when mounted into the water outlet, on the one hand deform in a controlled manner and, on the other hand, comprise a high restoring force for returning into their initial position such that the outer regions of the sealing lips exert permanently high pressure onto the joint to be sealed.

Said object is achieved by a generic sealing insert where
at least one circumferential bead-like thickening is arranged on the outside lateral surface of the annular body,
the sealing lip comprises a height which is greater than a spacing provided between the thickening,
   such that a sealing lip which folds over in the direction of the thickening is supported on the thickening.

In particular when inserting the sealing insert into a water outlet there is the risk of the sealing lips being irregularly loaded as a result of inserting the sealing lips in a tilted manner or non-coaxially to the inlet opening and, as a result of this, folding over and abutting against the outside lateral surface of the annular body. As a result of the thickening according to the invention, folding over of the sealing lip is restricted as soon as the sealing lip that folds over in the direction of the thickening contacts the thickening or the upper surface thereof with its apex region. The restricting of the folding over at the same time restricts the tensile and compressive forces in the sealing lip brought about by the folding over. As a result, the elastic tensioning range in the sealing lip is prevented from being exceeded and permanent deformation of the sealing lip, which makes it difficult or even totally impossible for the sealing lip to return into its initial position, is prevented. Thus, the initially deformed, elastic sealing lip is able to assume its original form again as the effect of the force diminishes due to the restoring force.

The cone surface portions preferably taper in the direction of the collar such that the side wall assumes its greatest thickness at a base of the lower sealing lips. For functional reasons, the outside diameter of the sealing lips is greater than the diameter of an opening into which the sealing insert is inserted. As the collar of the sealing insert projects above the sealing lips, the sealing insert can only be inserted in one direction, namely with the sealing lips first of all, into the opening. In this connection, the sealing lips are deformed against the direction of insertion in their outside region. The cone surface portions which connect to the sealing lips support the sealing lips in this connection. When the sealing insert is removed, the sealing lips are deformed in the opposite direction. As a result, this means that the resistance and the restoring force during insertion and with the sealing insert inserted are relatively high and when the sealing insert is removed, for example for repair work, are relatively low.

The sealing lips can describe a cylindrical or conical surface with their apices or outside edges, i.e. they can be located within a common or always decreasing or increasing radius, proceeding from a longitudinal axis of the annular body. In dependence on the intended purpose, it can consequently be provided that all the sealing lips comprise an outside diameter of identical size. However, it can also be provided that the diameter becomes greater or smaller from sealing lip to sealing lip such that the sealing lips together form a type of cone.

The width of the sealing lips, measured between the base of the sealing lip and its apex, preferably corresponds approximately to the spacing between two apices located one on top of another.

The outer, elastomer wall layer can be produced from thermoplastics material which is injected, for example, onto the harder inner wall layer in a known manner, or is subsequently fitted as a prefabricated moulded part. The inner wall layer can also consist of thermoplastics material, the hardness degree of which is adjusted in a corresponding manner. The inner wall layer can also consist of a thermosetting plastics material or a metal.

Finally, it is possible to produce the side wall which comprises the sealing lips integrally with the collar and the upper sealing ring. In this case, the regions provided for the sealing contact, such as the sealing lips and sealing ring, can be elastically deformable at least in part. The degree of hardness of the remaining material of the annular body can be adjusted such that the stability of the sealing insert is ensured.

The sealing inserts comprise a contour which is adapted to the waste trap. Said contour can be round or oval in particular.

### BRIEF DESCRIPTION OF THE DRAWINGS

Exemplary embodiments of the invention are explained in more detail by way of the drawing, in which:

FIG. 1 shows an oval sealing insert according to the invention in a top view of its sealing ring;

FIG. 2 shows a section A-A according to FIG. 1;

FIGS. 3 and 4 show a circular sealing insert according to the invention, in each case in a perspective view;

FIG. 5 shows an enlarged longitudinal-axial section through the sealing insert according to the invention, in a first realization;

FIG. 6 shows an enlarged longitudinal-axial section through the sealing insert according to the invention, in a second, optimized realization;

FIG. 7 shows an enlarged longitudinal-axial section through the sealing insert, in a solid realization;

FIG. 8 shows an installation position of the sealing insert according to the invention, in a schematic section in the floor region of a shower cubicle; and

FIG. 9 shows a sealing insert according to the prior art, in a section.

### DETAILED DESCRIPTION OF PREFERRED EMBODIMENTS

Identical or similar elements in the following figures can be provided with identical or similar references. In addition, the figures of the drawing, the description thereof as well as the claims include numerous features in combination. In this case, it is clear to an expert that said features can also be considered individually or they can be brought together to form further combinations which are not described in more detail here.

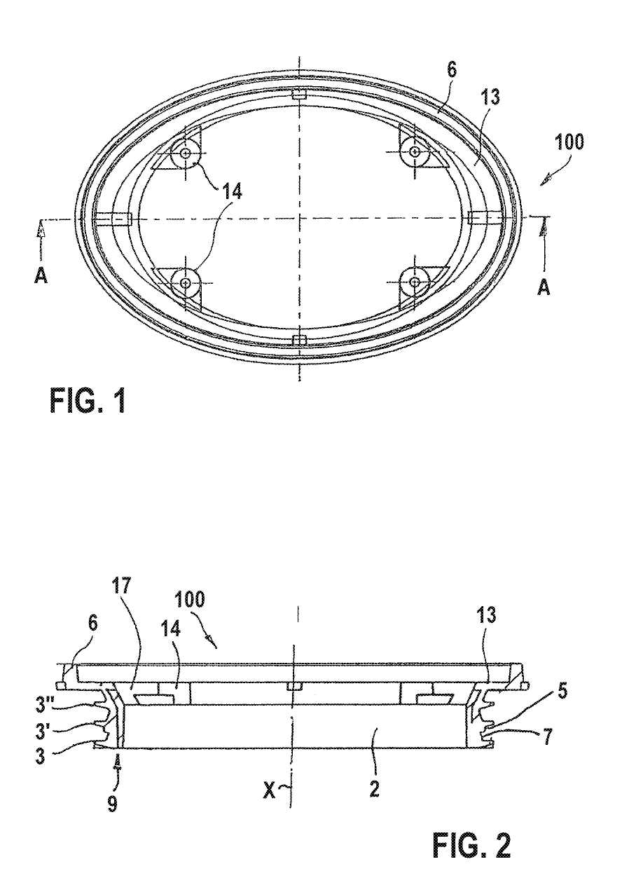

FIGS. 1 and 2 show a sealing insert 100 in its oval embodiment, said sealing insert including the annular body 1 with the side wall 9 and the circumferential upper collar 13 with the upwardly projecting sealing ring 6. The side wall 9 forms a central passage opening 2.

The side wall 9 consists of two wall layers 11, 12 which have been fitted together or pushed one on top of another, of which the one outer wall layer 11 is elastomer and incorporates three sealing lips 3, 3′, 3″ which are located one on top of another. The other inner wall layer 12 consists of a sturdy, relatively hard material.

Inwardly offset screw receiving elements 14 which are known per se are arranged on a tilted, upper portion 17 of the side wall 9.

FIG. 5 shows an optimized geometry (outline) of the side wall 9 in a longitudinal-axial section Q through the annular body 1. The sealing insert 100 comprises three sealing lips 3, 3′, 3″. The sealing lips 3, 3′, 3″ comprise in each case a conical contour K which ends in an apex 8 and merges into an outside lateral surface M of the side wall 9. As shown in FIG. 5, the sealing lips 3, 3′, 3″ are realized in a thicker manner compared to the sealing lips according to the prior art (cf. FIG. 9). A thickening 5 is provided in each case between the sealing lips 3 and 3′ as well as between the sealing lips 3′ and 3″. The thickenings 5 merge in each case into the base 15 of the sealing lip 3′ or 3″ located above them. There is a spacing B, which is smaller than the height H of the sealing lips, to the sealing lip 3 or 3′ located below. This ensures that a maximum a sealing lip which folds out in the direction of the thickening, in particular also in the case of irregular or one-sided loading, is able to fold out is until its apex region contacts the thickening 5 and is supported by said thickening. Depending on the requirement, one or several thickenings 5 can be provided on the sealing insert 100.

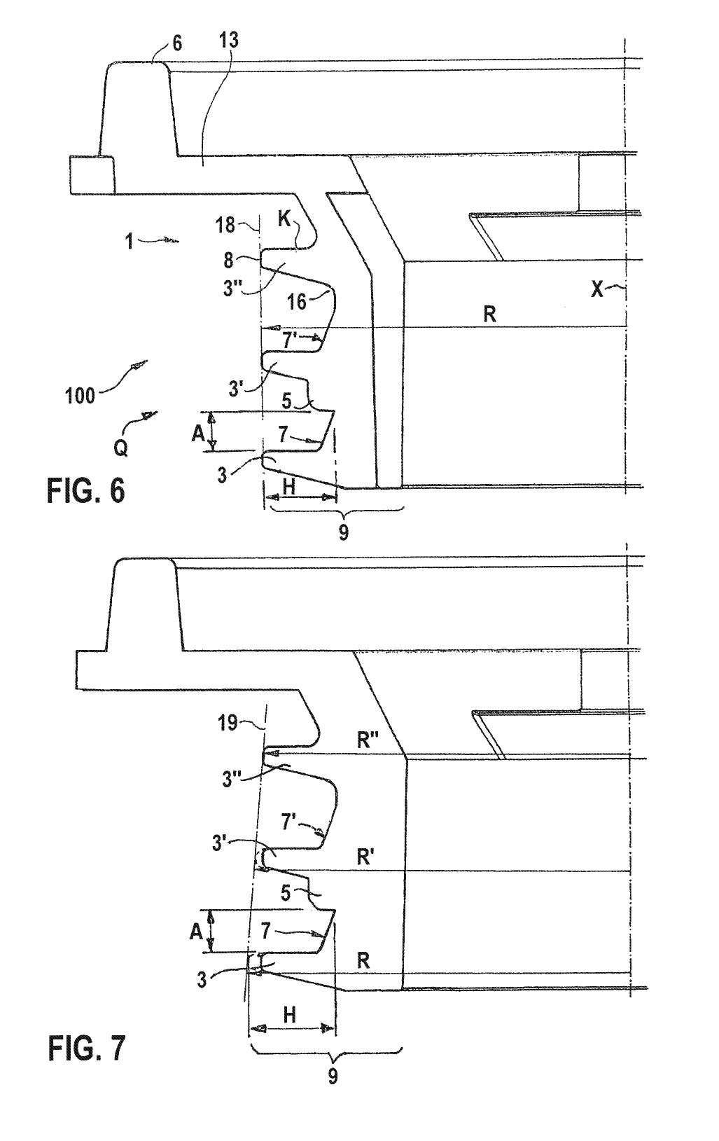

FIGS. 6 and 7 show a particularly advantageous realization where upwardly tapering cone surface portions 7, 7′ connect to the bead-like thickening 5. Analogous to the realization described in FIG. 5, the sealing lip 3 comprises a height H which is greater than a spacing B which is provided between the sealing lip 3 and the thickening 5.

As the risk of folding over is greatest with the first sealing lip 3 to be inserted into the opening of a floor or a floor panel, a bead-like thickening 5 is only provided underneath the second sealing lip 3′ in the exemplary embodiment shown in FIGS. 5 and 6. However, it is not ruled out that the sealing lips 3′ and/or 3″ are also supported by further bead-like thickenings.

According to FIGS. 6 and 7, the apices 8 of the sealing lips 3, 3′, 3″ that are located one on top of another are located along a line given the reference 18 which is arranged within a common radius R, measured from a longitudinal axis X of the annular body 1, that is to say parallel to the longitudinal axis X.

FIG. 7, however, shows a deviating realization where the apices 8 (designated by way of a dot-dash line) are arranged along a slightly inclined line 19. The apices 8 accordingly describe upwardly decreasing radii R, R′, R″, proceeding from the said longitudinal axis X of the annular body 1.

The sealing lips 3, 3′, 3″ can comprise stepped degrees of hardness or softness. For example, the upper sealing lip can be realized in a somewhat harder manner than the bottom one.

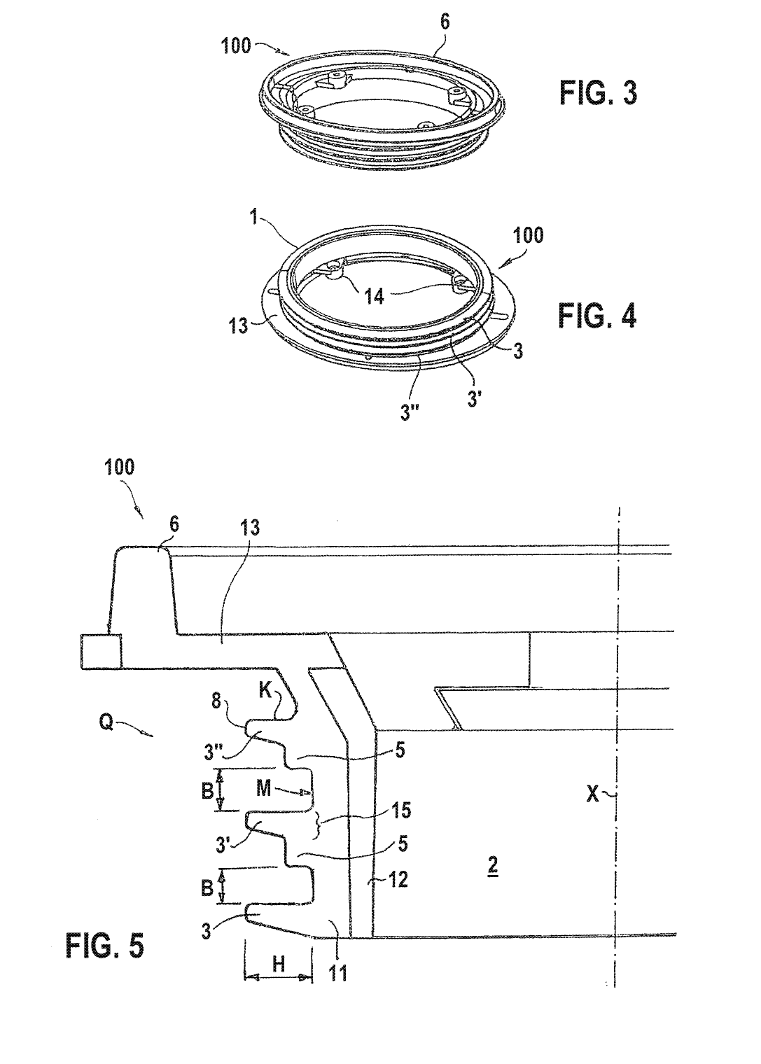

FIGS. 3 and 4 show the sealing insert 100 in its circular, rotationally symmetrical realization. The reference numerals of the circular sealing insert correspond to the parts of the oval sealing insert already described.

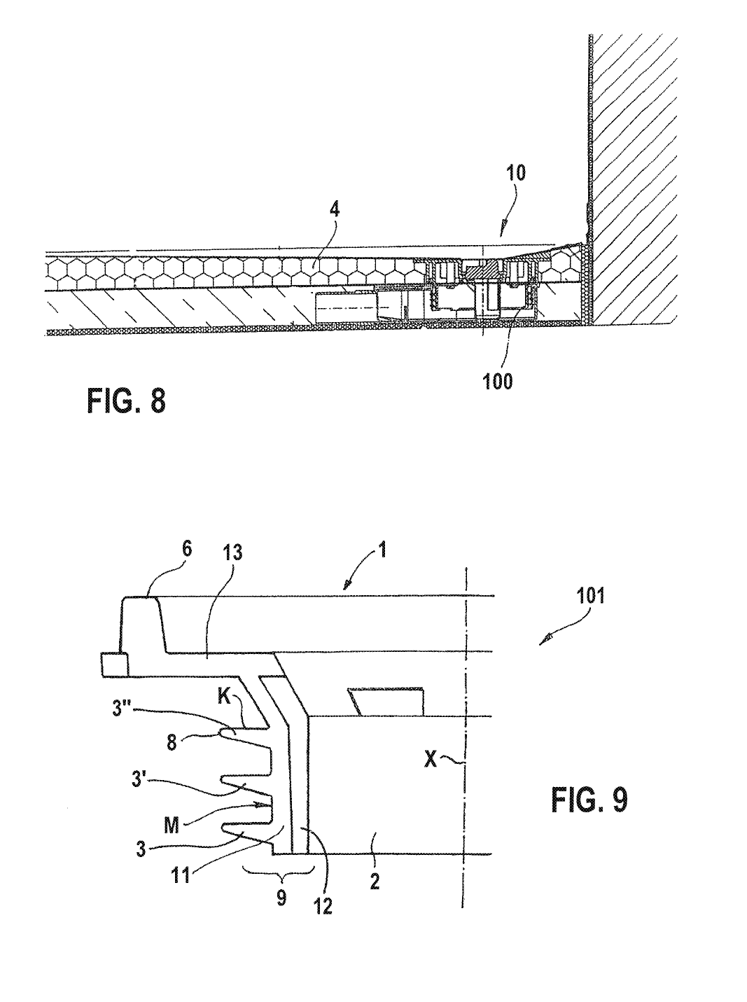

FIG. 8 shows the sealing insert 100 according to the invention, installed into a level water outlet 10 of a barrier-free shower. A panel-shaped shower floor element is designated by the reference numeral 4.

### LIST OF REFERENCE SIGNS

1 Annular body
2 Passage opening
3, 3′, 3″ Sealing lip
4 shower floor element
5 Thickening
6 Sealing ring
7, 7′ Cone surface portion (incline)
8 Apex
9 Side wall
10 Water outlet
11 Wall layer
12 Wall layer
13 Collar
14 Screw receiving element
15 Base
16 Concave rounding
17 Portion (of 9)
18 Line
19 Line
100; 101 Sealing insert
B Spacing
H Height
M Outside lateral surface
K Contour
Q Section
A-A Section
R, R′, R″ Radius
X Longitudinal axis

What is claimed is:

1. A sealing insert (100) for a water outlet (10), said sealing insert comprising an annular body (1) with a side wall (9) and a circumferential collar (13), at least one sealing lip (3, 3′, 3″) which is arranged on the side wall (9) and points outward, wherein in a longitudinal-axial section (Q) through the sealing insert (100), the sealing lip (3, 3′, 3″) comprises in each case a conical contour (K) which ends in an apex (8) and merges into an outside lateral surface (M) of the annular body (1), wherein:
at least one circumferential bead-like thickening (5) is arranged on the outside lateral surface (M) of the annular body; and
the sealing lip (3, 3′, 3″) comprises a height (H) which is greater than a spacing (B) provided between the thickening (5),
whereby a sealing lip (3, 3′, 3″) which folds over in the direction of the thickening (5) is supported on the thickening (5).

2. The sealing insert (100) according to claim 1, wherein the outside lateral surface (M) comprises at least one cone surface portion (7, 7′) which is arranged between the sealing lips (3, 3′, 3″).

3. The sealing insert (100) according to claim 2, wherein the cone surface portions (7, 7′) taper in the direction of the collar (13).

4. The sealing insert (100) according to claim 1, wherein the apices (8) of the sealing lips (3, 3′, 3″) located one on top of another are located, in the longitudinal-axial section (Q) through the sealing insert (100), within a common radius (R), proceeding from a longitudinal axis (X) of the annular body (1).

5. The sealing insert (100) according to claim 1, wherein the apices (8) of the sealing lips (3, 3′, 3″) located one on top of another are located, in the longitudinal-axial section (Q) through the sealing insert (100), within different radii (R, R′, R″), proceeding from a longitudinal axis (X) of the annular body

6. The sealing insert (100) according to claim 1, wherein the side wall (9) consists of two wall layers (11; 12) which are firmly joined to one another.

7. The sealing insert (100) according to claim 6, wherein the one wall layer (11) consists of elastomer material and incorporates the sealing lips (3, 3′, 3″), whereas the other wall layer (12) consists of harder material than that of the elastomer wall layer (11).

8. The sealing insert (100) according to claim 1, wherein the annular body (1) is produced in one material piece, wherein the regions provided for the sealing contact, such as sealing lips (3, 3′, 3″), are elastically deformable at least in part, whereas the remaining material of the annular body (1) is more rigid.

9. The sealing insert (100) according to claim 1, wherein the collar 13 comprises an upwardly projecting sealing ring 6 and wherein, when seen in a top view of the sealing ring (6), the annular body (1) is circular.

10. The sealing insert (100) according to 1, wherein the collar 13 comprises an upwardly projecting sealing ring 6 and wherein, when seen in a top view of the sealing ring (6), the annular body (1) is oval.
